(19) United States
(12) Patent Application Publication
(10) Pub. No.: US 2023/0138406 A1
(43) Pub. Date: May 4, 2023

(54) ROTARY VALVE WITH COMPENSATION ELEMENT TO COMPENSATE FOR AXIAL MISALIGNMENT

(71) Applicant: Agilent Technologies, Inc., Santa Clara, CA (US)

(72) Inventor: Armin Steinke, Ettlingen (DE)

(21) Appl. No.: 17/979,721

(22) Filed: Nov. 2, 2022

(30) Foreign Application Priority Data
Nov. 3, 2021 (DE) 102021128649.2

(51) Int. Cl. G01N 30/20

(52) U.S. Cl. CPC G01N 30/20; G01N 2030/202; G01N 2030/027

(57) ABSTRACT

A valve, such as for a high performance chromatography system for separating components of a sample liquid introduced into a mobile phase, includes a rotor and a stator, wherein a flow path can be established or inhibited by a rotational movement of the rotor relative to the stator. The valve also includes a compensation element, which is axially arranged together with the rotor and the stator and, in an operating state of the valve, causes an axial pressing of the rotor relative to the stator. The compensation element includes at least one spherical surface to compensate for an axial misalignment between the rotor and the stator.

### RELATED APPLICATIONS

The present application claims the benefit of German patent application No. 10 2021 128 649.2, filed on Nov. 3, 2021, which is hereby incorporated by reference in its entirety.

### TECHNICAL FIELD

The present disclosure relates to flow elements, particularly for HPLC applications.

### BACKGROUND ART

In high performance liquid chromatography (HPLC), a liquid must be conveyed at typically very precisely controlled flow rates (e.g., in the range of nanoliters to milliliters per minute) and at a high pressure (typically 20-100 MPa and beyond, currently up to about 200 MPa), taking into account the respective compressibility. For liquid separation in an HPLC system, a mobile phase, which—in operation—comprises a sample liquid with components to be separated, is driven through a stationary phase (such as a chromatographic column) in order to separate different components of the sample in this way. In doing so, the composition of the mobile phase can be constant over time (isocratic mode) or vary (e.g. in the so-called gradient mode).

Valves are frequently used in liquid chromatography to either enable or interrupt flow paths, e.g. of the mobile phase. Typically, rotary valves (shear valves) are used, in which a rotor can be moved in rotation relative to a stator in order to switch corresponding flow paths. At the high pressures common in HPLC in the range of 100 MPa and more, a suitable fluidic seal is required especially between the stator and rotor. For this purpose, the rotor and stator are usually subjected to a high axial contact pressing force in order to achieve the fluidic seal. Mechanical tolerances, wear and other influencing variables can counteract the fluidic seal.

DE102012107378A1 describes a switching valve for liquid chromatography with a compensation element for acting on the rotor to transmit an axial contact pressing force to the stator. The compensation element comprises a bending area which allows elastic bending deformation in such a way that even if the rotor wobbles, it is subjected to the full surface pressure.

### SUMMARY

It is an object of the present disclosure to improve the fluidic sealing of a rotary valve, especially for HPLC applications.

One embodiment relates to a valve, preferably in a high performance chromatography system for separating components of a sample liquid introduced into a mobile phase. The valve comprises a rotor and a stator, wherein a flow path can be established or inhibited by a rotational movement of the rotor relative to the stator. The valve further comprises a compensation element which is axially arranged together with the rotor and the stator, and which, in an operating state of the valve, effects an axial pressing of the rotor against the stator. The compensation element comprises at least one spherical surface to compensate for axial misalignment between the rotor and the stator. The compensation element can thus form one or more bearing points that can roll spherically on each other. The compensation element may thus have one or more pivot points to counteract and preferably compensate for the axial misalignment between the rotor and the stator. The compensation element can further also reduce or compensate for lateral misalignment, for example of the rotor, for example by the compensation element allowing tilting in the axial direction.

In one embodiment, the compensation element comprises one or more pivot points, each formed by a spherical surface.

In one embodiment, the pivot point or pivot points each comprise a bearing location where two of the spherical surfaces roll on each other.

In one embodiment, the compensation element comprises two spherical surfaces, so that in case of an axial misalignment between the rotor and the stator, the spherical surfaces can move against each other to compensate for the axial misalignment.

In one embodiment, the compensation element is configured to compensate for a lateral offset of the rotor relative to the stator.

In one embodiment, the compensation element is arranged together with the rotor and the stator axially in the direction of an axis of rotation of the rotor.

In one embodiment, the compensation element is configured such that in the operating state of the valve, an axial force acts on the at least one spherical surface to cause the axial pressing of the rotor with respect to the stator.

In one embodiment, the valve comprises a drive for moving the rotor.

In one embodiment, the drive comprises a rotatable shaft that can in particular be driven by a motor.

In one embodiment, the compensation element is arranged axially between the drive and the rotor or the stator.

In one embodiment, the compensation element is arranged axially between a housing of the valve and the stator. Preferably, the compensation element acts axially on a first side of the stator, the drive acts via the rotor on a second side, and the second side is arranged axially opposite to the first side.

In one embodiment, the compensation element comprises a first end and a second end axially disposed in opposite directions in the operating state of the valve, wherein the first end comprises a first spherical surface such that the compensation element can tilt axially at the first spherical surface to compensate for the axial misalignment between the rotor and the stator.

In one embodiment, the second end of the compensation element comprises a second spherical surface such that the compensation element can tilt at the second spherical surface to compensate for the axial misalignment between the rotor and the stator, wherein in particular a direction of lift-off at the second spherical surface is opposite to a direction of lift-off at the first spherical surface.

In one embodiment, the compensation element has an elongated shape in the axial direction.

In one embodiment, the compensation element comprises at least one ball joint with at least one spherical surface, in particular two ball joints at axially opposite ends of the compensation element.

In one embodiment, by a relative movement of the rotor with respect to the stator, a first effective surface of the rotor can be brought into contact or connection with a second effective surface of the stator and a flow path can be established or inhibited.

In one embodiment, the valve is a high pressure switching valve for high performance liquid chromatography.

In one embodiment, the valve comprises a housing in which one or more of the rotor, the stator, the drive, and the compensation element are disposed.

In one embodiment, the stator comprises a plurality of connection ports, each for being able to provide a fluidic coupling.

In one embodiment, the rotor cooperates with the stator in predetermined switching positions defined by associated angular positions to fluidically connect or disconnect predetermined connection ports.

In one embodiment, the rotor is rotatably mounted by means of, in particular in a disposed bearing and pressing device, and is subjected to a predetermined pressing force in the direction of the stator.

In one embodiment, the bearing and pressing device comprises the compensation element that acts on the rotor to transmit the pressing force.

In one embodiment, the compensation element comprises a head portion that acts on the rotor with an application surface.

In one embodiment, the compensation element comprises a foot portion with which the compensation element is supported against a unit of the bearing and pressing device that generates the pressing force or against an element of the bearing and pressing device that transmits the pressing force.

In one embodiment, the compensation element is configured in such a way that the application surface of the head region impacts the rotor over the entire surface, even during wobbling movements of the rotor, in any angular position of the rotor, and a substantially uniform pressure distribution is thereby generated in the plane of contact between the rotor and the stator.

In one embodiment, the compensation element is formed as a rod-shaped element, and it is in particular made of steel or ceramic.

In one embodiment, the rotor is axially fixed within the valve and the stator is configured such that it can elastically align with respect to the rotor.

In one embodiment, the stator is axially fixed within the valve and the rotor is configured such that it can elastically align with respect to the rotor.

In one embodiment, the rotor comprises a first effective surface and the stator comprises a second effective surface. By a relative movement of the rotor relative to the stator, the first effective surface can be brought into contact or connection with the second effective surface and a flow path can be established or inhibited. The stator comprises an elastic region to compensate for an axial angle between the rotor and the stator so that the first effective surface and the second effective surface can be aligned parallel to each other.

In one embodiment, the stator comprises an outer region and an inner region, the inner region comprises the second effective area, and the outer region is connected to the inner region via the elastic region so that the inner region is elastically movable relative to the outer region through the elastic region.

In one embodiment, the outer portion is fixed with respect to the rotor and the inner portion can elastically align with respect to the rotor.

In one embodiment, the elastic region comprises one or more webs, each of which is connected to the outer region on one side and to the inner region on the opposite side, such that the inner region can tilt with respect to the outer region.

One embodiment relates to a high performance chromatography system comprising a pump for moving a mobile phase, a stationary phase for separating components of a sample liquid introduced into the mobile phase, and a valve according to any of the previously mentioned embodiments for establishing or inhibiting a flow path of the mobile phase.

One embodiment relates to a method, in particular in a high performance chromatography system, for separating components of a sample liquid introduced into a mobile phase. The method relates to a valve comprising a rotor and a stator, wherein a flow path can be established or inhibited by rotational movement of the rotor relative to the stator. The method comprises compensating for an axial misalignment between the rotor and the stator by forming a pivot point on at least one spherical surface.

Embodiments of the present disclosure can be carried out on the basis of many of the known HPLC systems, such as the Agilent Infinity Series 1290, 1260, 1220, and 1200 systems from the applicant Agilent Technologies, Inc., see www.agilent.com.

A pure solvent or a mixture of different solvents can be used as mobile phase (or eluent). The mobile phase can be chosen such as to minimize the retention time (response time) of liquid components of interest and/or the amount of mobile phase for conducting the chromatography. The mobile phase can also be chosen such that specific components are effectively separated. It may comprise an organic solvent, such as methanol or acetonitrile, which is often diluted with water. For a gradient operation, water and an organic solvent (or other solvents commonly used in HPLC) are often varied in their mixing ratio over time.

One or more of the methods explained above may be controlled, supported or executed in whole or in part by software when running on a data processing system, such as a computer or workstation. The software may be stored on a data carrier in the process or for this purpose.

### BRIEF DESCRIPTION OF THE DRAWINGS

The disclosure is further explained below with reference to the drawings, wherein like reference characters refer to like or functionally like or similar features.

FIG. 1 shows an example of a liquid separation system according to embodiments of the present disclosure, as used, for example, in HPLC.

FIG. 2 shows an example of a valve, as it can for example be used in a sample injector of a liquid separation system, according to an embodiment of the present disclosure.

FIG. 3 shows schematically and in sectional view an example of a valve according to another embodiment of the present disclosure.

FIG. 4A is a schematic cross-sectional view of an example of a valve according to another embodiment of the present disclosure.

FIG. 4B illustrates exemplarily and schematically an alternative embodiment of a compensation element of a valve compared to FIG. 4A.

FIG. 5 shows an example of an elastic stator in sectional view (top) and schematic top view (bottom), such as may be utilized in the valve illustrated in FIG. 4A, according to an embodiment of the present disclosure.

FIG. 6 shows schematically and in sectional view an example of a valve according to another embodiment of the present disclosure.

FIG. 7 shows schematically and in sectional view an example of a valve according to another embodiment of the present disclosure.

FIG. 8 shows schematically and in sectional view an example of a valve according to another embodiment of the present disclosure.

FIG. 9 shows schematically and in sectional view an example of a valve according to another embodiment of the present disclosure.

FIG. 10 shows schematically and in sectional view an example of a valve according to another embodiment of the present disclosure.

### DETAILED DESCRIPTION

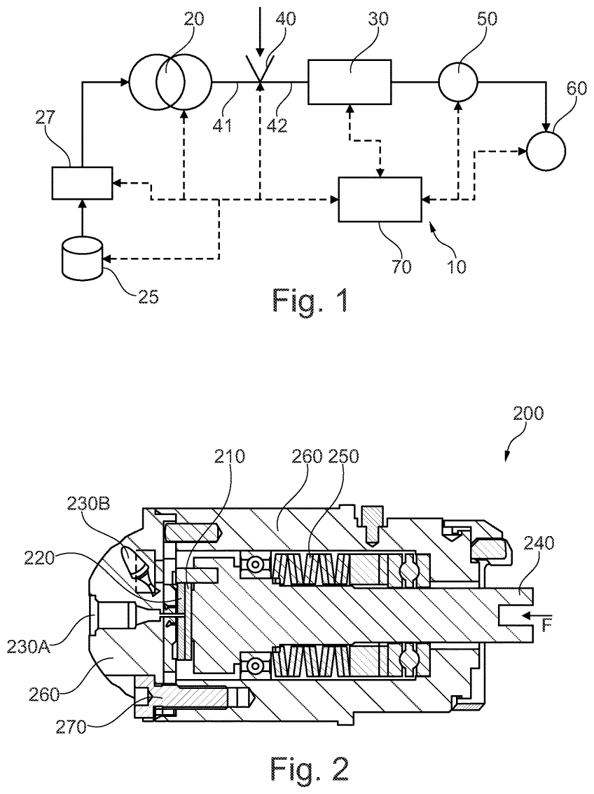

Specifically, FIG. 1 shows a general illustration of a liquid separation system 10. A pump 20 receives a mobile phase from a solvent supply 25, typically via a degasser 27, which degasses the mobile phase and thereby reduces the amount of dissolved gases in the mobile phase. The pump 20 drives the mobile phase through a separation device 30 (such as a chromatographic column), which has a stationary phase. A sample device (or sample injector) 40 may be provided between the pump 20 and the separation device 30 to deliver a sample fluid into the mobile phase. A fluidic conduit between the pump 20 and the sample injector 40 shall be denoted by a reference numeral 41, and a fluidic conduit between the sample injector 40 and the separation device 30 shall be denoted by a reference numeral 42. The stationary phase of the separation device 30 is adapted to separate components of the sample fluid. A detector 50 detects separated components of the sample fluid, and a fractioning device 60 may be provided to output the separated components.

The mobile phase may comprise only one solvent or a mixture of different solvents. The mixing can be done at low pressure and upstream of the pump 20, so that the pump 20 already conveys the mixed solvent as mobile phase. Alternatively, the pump 20 may comprise individual pump units, each pump unit conveying one solvent or solvent mixture at a time, so that the mixing of the mobile phase (as then seen by the separation device 30) occurs at high pressure and downstream of the pump 20. The composition (mixture) of the mobile phase may be kept constant over time (isocratic mode) or varied over time in a so-called gradient mode.

A data processing unit 70, which may be a conventional personal computer or a workstation, may be coupled to one or more of the devices in the fluid separation system 10, as indicated by the dashed arrows, to receive information and/or to control the operation of the system or individual components therein.

FIG. 2 shows an example of a valve 200, such as it may be used in the sample injector 40, e.g. for injecting the sample fluid into the mobile phase. Such injectors including switchable valves are sufficiently known in the prior art, such as from WO2010139359A1, US20160334031A1 or US2017343520A1, all of the same applicant. The first two documents show the injector in a so-called flow-through configuration, in which a sample loop containing the sample fluid is connected between the pump and the separation device during injection. The third document, on the other hand, describes an injector in the so-called feed-injection configuration, in which the sample fluid is pressed or forced into the mobile phase between the pump and the separation device by means of a T-coupling, so that a sample flow containing the sample fluid is added to the flow of the mobile phase.

The valve 200 exemplarily shown in FIG. 2 is a so-called rotary valve, in which a rotor 210 and a stator 220 rotate relative to each other, wherein the rotor 210 is typically being rotated with respect to the stator 220. Both the rotor 210 and the stator 220 may thereby have so-called ports in them, each presenting an open end to a respective flow path that may be connected to the valve 200 via respective ports 230A, 230B, etc. Furthermore, both rotor 210 and stator 220 can comprise corresponding connecting elements (e.g. recesses such as notches, grooves etc.) which can fluidically connect one or more ports with each other by relative movement of rotor 210 and stator 220. This is shown only schematically in FIG. 2 and is sufficiently known in the prior art, e.g. from the documents mentioned above. It is also known that so-called translation valves can be used as an alternative to rotary valves, in which a translational movement is performed instead of a rotational movement.

In the exemplary embodiment of FIG. 2, the valve 200 further shows a drive 240 for moving the rotor 210, for example a rotatable shaft that may be driven by a motor, for example. The drive 240 may be fixedly connected to the rotor 210 or may even be an integral part thereof. The drive 240 together with the rotor 210 is preferably elastically/resiliently pressed against the stator 220, e.g. by means of a spring assembly 250. Rotor 210, drive 240 and spring assembly 250 may be arranged in a housing 260. The stator 220 together with the connections 230 may preferably be arranged in a valve head 270, which may be connected to the housing 260, for example by means of a screw connection 270.

For example, the valve 200 may be connected such that the fluidic conduit 41 is connected to the port 230A and the fluidic conduit 42 is connected to the port 230B. By suitable design of the rotor 210 and the stator 220, in particular by design of suitable connecting elements, a desired functionality in the fluidic coupling between the fluidic conduits 41 and 42 can be designed, as is sufficiently known in the prior art.

In order to bring about fluidic tightness, e.g. in the fluid path between the conduits 41 and 42, between the rotor 210 and the stator 220, in the prior art an appropriate dimensioning of the spring assembly 250 or another static biasing mechanism is usually proposed so that the rotor 210 presses axially against the stator 220 with a desired sealing force F (i.e. in the direction of the sealing force F). A sealing force F that is too low can result in leakage (in particular between rotor 210 and stator 220), while a sealing force F that is too high can result in increased wear (in particular of the friction components between rotor 210 and stator 220).

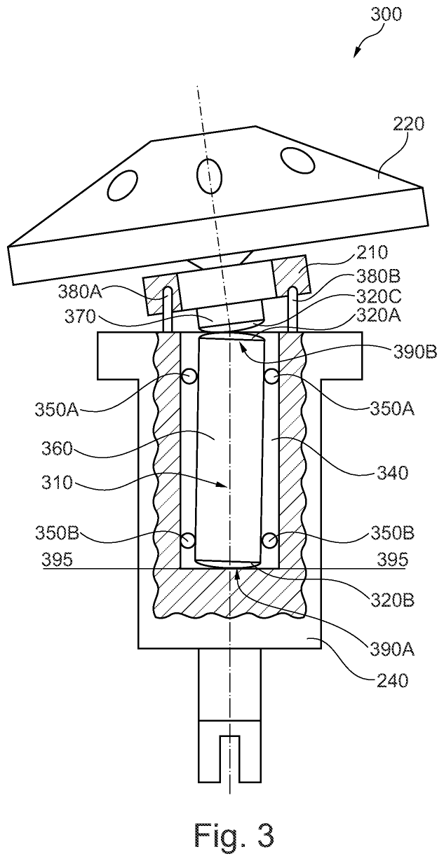

FIG. 3 shows schematically and in sectional view an embodiment of a valve 300, which essentially corresponds to the valve 200 shown in FIG. 2, so that reference numerals are used accordingly. The housing 260 (not shown in FIG. 3) contains the rotor 210, which abuts against the stator 220 and can be driven in rotation by the drive 240. A bearing (not shown in FIG. 3), e.g. an axial thrust bearing, can support the drive 240 in axial direction.

The valve 300 further comprises a compensation element 310 to accomplish an axial pressing of the rotor 210 with respect to the stator 220. For this purpose, the compensation element 310 is arranged together with the rotor 210 and the stator 220 in the axial direction of the valve 300, where axial is to be understood with respect to an axis of rotation of the valve 300. In order to be able to compensate for an axial misalignment or offset between the rotor 210 and the stator 220, the compensation element 310 comprises at least one spherical surface 320, which will be discussed in more detail below.

In the embodiment according to FIG. 3, the compensation element 310 is arranged in an axial recess or cavity 340 of the drive 240, wherein one or more preferably elastic elements 350, such as the O-rings 350A and 350B shown in FIG. 3, may be arranged radially between the compensation element 310 and a surface of the axial cavity 340 to support and position the compensation element 310 within the axial cavity 340. The resilient elements 350 may also facilitate mounting of the valve 300, in particular the compensation element 310 within the drive 240.

In the embodiment according to FIG. 3, the compensation element 310 comprises an elongated base body 360 extending substantially in the axial direction. The elongated base body 360, which may be a cylinder for example, comprises a spherical surface 320A at its upper (with respect to the embodiment in FIG. 3) end face and a spherical surface 320B at its lower end face.

In the initial example shown in FIG. 3, a further spherical surface 320C is shown extending along an axial end face of a spacer element 370 and facing the spherical surface 320A. This spacer element 370 can be associated (spatially) with either the compensation element 310 or, in this case, the stator 210 and interacts functionally with the compensation element 310.

Furthermore, one or more drivers 380A, 380B, etc. can be arranged between the drive 240 and the rotor 210, which are inserted loosely between the drive 240 and the rotor 210, for example as pins, and which effect transmission of a rotational movement of the drive 240 to the rotor 210 in the sense of an inhibitor or a locking mechanism, preferably without thereby firmly coupling the rotor 210 (in particular axially) with respect to the drive 240. Accordingly, other mechanical designs are also possible in the transfer and transmission of the rotational movement.

In the schematically illustrated embodiment example according to FIG. 3, the compensation element 310 is designed and arranged or fastened in the valve 300 in such a way that an axial angular offset between stator 220 and rotor 210 can be compensated at least to a certain degree and thus the effective surfaces of stator 220 and rotor 210 lie parallel opposite or flat against each other, as shown in FIG. 3.

In the embodiment shown in FIG. 3, the compensation element 310 forms two bearing locations 390, namely a first bearing location 390A and a second bearing location 390B. The first bearing position 390A is formed by the spherical surface 320B, which can roll off with respect to an axial end surface 395 of the axial recess 340. The second bearing position 390B is formed by the two adjacent spherical surfaces 320A and 320C, which can roll on each other.

In the example shown in FIG. 3, the stator 220 is intentionally shown at an exaggerated axial angle relative to the drive 240, e.g., due to or caused by appropriate tolerances, abrasion, and/or a less than optimal assembly. The compensation element 310 may tilt relative to the axis of rotation of the drive 240 at the first bearing location 390A, squeezing the upper O-ring 350A on the right and the lower O-ring 350B on the left (each in the drawing representation shown in FIG. 3). The spacer element 370 is tilted at the second bearing location 390B relative to the compensation element 310, so that as a result the active surfaces of rotor 210 and of stator 220 are flat opposite to each other and pressed against each other. The drivers 380 allow such tilting of the rotor 210 relative to the drive 240.

In addition to compensating for any axial angular misalignment between rotor 210 and stator 220, both bearing locations 390A and 390B also allow no or little lateral radial misalignment between rotor 210 and stator 220 to result from such axial angular misalignment.

The number and positioning of the spherical surfaces 320 is not limited or fixed according to the exemplary embodiment according to FIG. 3. For example, the axial end face 395 could also be designed as a spherical surface. Alternatively, only a single spherical surface 320 could also be sufficient to achieve an axial compensation between rotor 210 and stator 220, in which case a lateral radial offset or misalignment between rotor 210 and stator 220 may result.

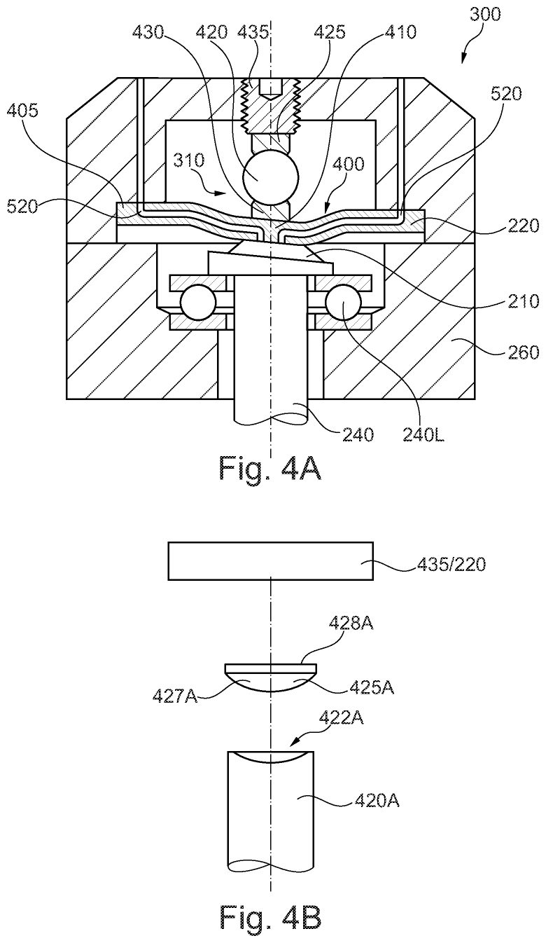

FIG. 4A illustrates schematically and in sectional view another embodiment of a valve 300 substantially corresponding to the one shown in FIG. 3. The stator 220 is fixedly connected to the housing 260, e.g. by means of appropriate mechanical fasteners. An optional thrust bearing 240L supports the drive 240 in the axial direction. The housing 260 may be of one-piece construction or of multiple-piece construction, such as two-piece construction for simplified assembly, as shown in FIG. 4A.

Furthermore, in the embodiment shown in FIG. 4A, the stator 220 is elastic in that it can elastically align itself axially and/or radially with respect to the rotor 210 despite being rigidly connected to the housing 260, as is deliberately exaggerated in FIG. 4A. To this end, in the exemplary embodiment shown in FIG. 4A, the stator 220 is configured to include an elastic region 400 located between a mounting region 405 and an abutment region 410. The attachment region 405 represents the region where the stator 220 is attached relative to the housing 260. Preferably, and as exemplarily shown in FIG. 4A, fluidic connection points for fluidic coupling of the stator are located in or within the mounting region 405. The abutment region 410 represents the area in which the stator 260 is in contact with the rotor 210, i.e. in which the effective area of the stator 220 required for the valve function is located.

The compensation element 310 in the exemplary embodiment according to FIG. 4A is formed by a spherical body 420, an upper shell 425 and a lower shell 430. Preferably, both the upper shell 425 and the lower shell 430 are designed with a spherical surface in their surface/side opposite or adjacent to the spherical body 420, preferably concave, e.g. with a radius corresponding to or (in particular slightly) larger than that of the spherical body 420.

The upper shell 425 or the lower shell 430 can also be firmly (integrally) connected to the spherical body 420, e.g. by a suitable forming or bonding (e.g. soldering, welding, gluing, etc.). Correspondingly, the other shell 425/430 that is not fixedly connected to the spherical body 420 can then also be designed in such a way that its surface/side opposite the spherical body 420 does not have a spherical surface, but is designed to be planar, for example. In such an exemplary embodiment, the compensation element 310 then comprises only one spherical surface, namely that of the spherical body 420, which is opposite or in contact with the shell 425/430 (which is not fixedly connected to the spherical body 420). The up to three elements of the compensation element 310 in the embodiment according to FIG. 4A can also be appropriately pre-assembled and/or held together, for example, by means of a rubber hose, in order to accomplish a simplified assembly.

In the embodiment according to FIG. 4A, an axial pressing mechanism 435 (e.g., a corresponding screw mechanism, as exemplarily shown) preferably connected to the housing 260 may further be provided to position the compensation element 310 axially relative to the stator 220 and, for example, to bias or press the stator 220 axially tightly relative to the rotor 210. Further or alternatively, an axial spring element may also be implemented to accomplish an elastic (resilient) axial bias. Accordingly, an elasticity of the housing 260 may also be utilized.

When operating the valve 300, an axial angular misalignment, for example, between the rotor 210 and the housing 260, as exemplarily shown in FIG. 4A, can be at least partially compensated for and offset (at least in part) by the compensation element 310 in that the at least one spherical surface forms a bearing location in which the spherical surface can roll. For example, if both the upper shell 425 and the lower shell 430 are rotatable relative to the spherical body 420, i.e., with spherical surfaces both between the spherical body 420 and the upper shell 425 and between the spherical body 420 and the lower shell 430, the lower shell 430 can roll relative to the upper shell 425 and compensate for the axial angular misalignment. The same also applies if, for example, only the upper shell 425 or only the lower shell 430 is designed to be movable relative to the spherical body 420.

In addition to compensating for an axial angular misalignment between rotor 210 and stator 220, the one or more bearing locations 390A and 390B further allow for no or little lateral radial misalignment between rotor 210 and stator 220 to result from such axial angular misalignment.

In contrast to the embodiment according to FIG. 3, in which the compensation element 310 comprises an elongated base body 360 so that the elongated base body 360 can tilt, the compensation element 310 according to FIG. 4A can be designed and arranged in such a way that a pure rotation about the spherical center of the spherical body 420 takes place. Conversely, the body 420 can also be designed not as a sphere but, for example, as an axially elongated body in order to achieve a corresponding tilting.

FIG. 4B illustrates exemplarily and schematically an alternative embodiment of the compensation element 310 compared to FIG. 4A. At least one of the shells 425 or 430, which are concave in FIG. 4B, is convex in FIG. 4B as shell 425A with a spherical surface 427A. Accordingly, the spherical body 420 is replaced, for example, by a cylinder 420A having a concave recess 422A that cooperates with the spherical surface 427A of the shell 425A. Opposite to the spherical surface 427A, the shell 425A may comprise a preferably planar surface 428A, which in turn may correspondingly abut against another planar surface, for example of the contact pressure mechanism 435 or of the stator 220.

In FIG. 4B, only one axial side of the cylinder 420A is designed and shown schematically, namely the concave recess 422A. The axially opposite side of the cylinder 420A can also have a concave recess, for example, or be flat, for example, according to the respective application.

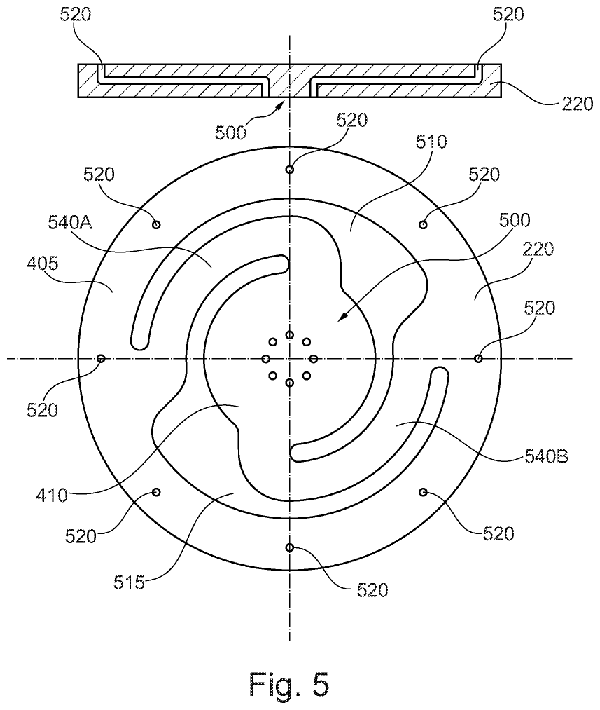

FIG. 5 shows—isolated from the valve 300—an embodiment of the elastic stator 220 used in FIG. 4A in sectional view (top) and schematic top view (bottom). A plurality of ports 500 are centrally formed in the abutment region 410 of the stator 220. The ports 500 each provide an open end to a respective flow path and cooperate with corresponding connecting elements (such as grooves) of the stator 210 to interconnect respective flow paths.

The abutment region 410 (with the ports 500) is designed as a flexible region, which is achieved in the exemplary embodiment according to FIG. 5 by two recesses 510 and 515. The two recesses 510 and 515 allow—to a certain degree—a twisting (in particular a tilting) of the abutment region 410, so that it lies as flat as possible against the rotor 210, even in case of a twisting or tilting of the stator 220 against the rotor 210.

The stator 220 further comprises external ports 520, exemplarily shown in the exemplary embodiments of FIGS. 4 and 5, which may correspond, for example, to the ports 230 in FIG. 2, i.e., and which may serve for external fluidic contacting of the stator 220.

The stator 220 in the exemplary embodiment according to FIG. 5 may further comprise mounting holes (not shown in more detail here) or the like for mechanically coupling and/or fixing the stator 220 e.g. with respect to the housing 260.

In addition to the abutment region 410, which includes the ports 500, the stator 220 comprises the mounting region 405 (which may be formed as a ring, as shown here) and two webs 540A and 540B, each of which extends between and is connected to the abutment region 410 and the mounting region 405. Only one web or more than the two webs 540 shown here may also be implemented, and of course these webs 540 may have a different shape than the one that is shown here. Preferably, fluidic connections between the ports 500 and connections (interface ports) 520 in the mounting region 405 may be guided in these webs 540.

Due to the webs 540, the abutment region 410 is elastically movable relative to the (outer) mounting region 405 and is thus pronounced as a flexible area, so that the abutment region 410 can move relative to the mounting region 405, in particular in the axial direction (of the valve 300). Furthermore, this flexible structure also allows the abutment region 410 to be twisted/tilted relative to the mounting region 405, i.e. the surface of the abutment region 410 that is in contact with the rotor 210 can be angled/tilted relative to the surface in which the mounting region 405 is located.

Preferably, the plurality of ports 500 are centrally located in the abutment region 410 of the stator 220. The ports 500 each provide an open end to a respective flow path and cooperate with corresponding connecting elements (such as grooves) of the stator 210 to interconnect corresponding flow paths. The abutment region 410 (with the ports 500) is pronounced as a flexible region by the two recesses 510 and 515. The two recesses 510 and 515 allow—to a certain extent—tilting of the abutment region 410, so that the abutment region 410 lies as flat as possible against the rotor 210, even in case of tilting or canting of the stator 220 relative to the rotor 210.

In FIG. 5 above, the stator 220 is shown with no force applied, i.e., in a sort of resting position. As deliberately exaggerated in FIG. 4A, the stator 220 can elastically deform in the event of an axial angular misalignment (e.g. between the rotor 210 and the housing 260, as exemplarily shown in FIG. 4A) to compensate for such an axial angular misalignment.

The stator 220 shown in FIGS. 4 and 5 can preferably be implemented with microfluidic structures, preferably based on interconnected metal layers, also referred to as metal microfluidic or MMF structures. In one exemplary embodiment (not shown in detail here), the stator 220 is constructed from a plurality of metal layers (e.g., four metal layers or more), each of which has preferably been tightly bonded together by diffusion bonding. One or more fluidic channels may be formed by suitable recesses in the metal layers and flowed through by a fluid, such as the mobile phase. Such channels can also be at least partially surrounded by ceramic inserts, which are inserted, for example, as bonding auxiliaries during the bonding process, and preferably serve the manufacturing process to prevent or reduce subsidence of the geometry.

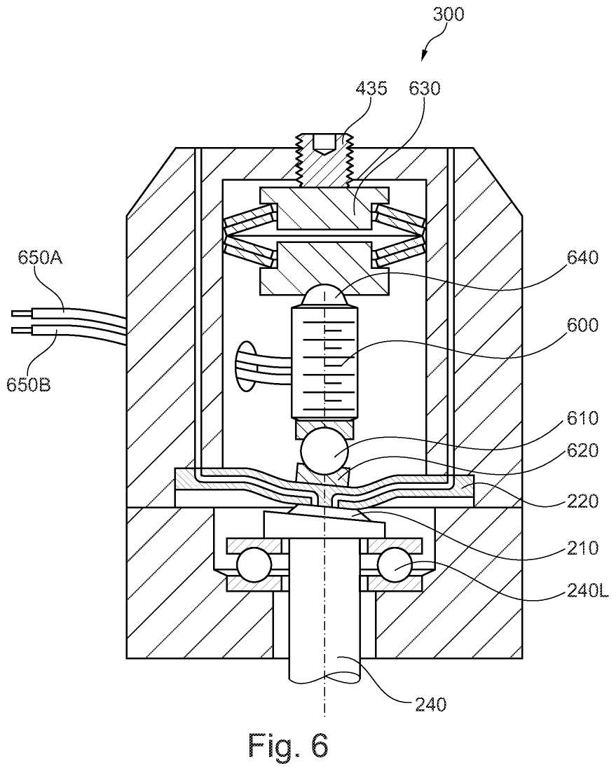

FIG. 6 shows schematically and in sectional view another embodiment of the valve 300. In contrast to the embodiment according to FIG. 4A but corresponding to the embodiment according to FIG. 3, the compensation element 310 in FIG. 6 comprises an elongated body 600. In addition, the compensation element 310 comprises a ball 610 and a shell 620. Furthermore, an optional elastic spring element 630 is implemented between the contact pressure mechanism 435 and the compensation element 310 in order to be able to achieve a resiliently elastic axial contact pressure of the stator 220 relative to the rotor 210.

By implementing one or more spherical surfaces, one or more bearing locations of the compensation element 310 can be achieved. For example, (referring to FIG. 4A) a bearing location may be implemented between the ball 610 and the shell 620 and/or between the ball 610 and the elongated body 600. Accordingly, an end face 640 of the elongated body 600 opposite the ball 610 in the axial direction may also comprise a spherical surface and, together with the resilient spring element 630, form a further bearing point. It can be seen that several bearing points allow further degrees of freedom in a compensation of an axial angular displacement.

In one embodiment, the body 600 is configured to perform axial length variation. For example, the body 600 may be implemented as or include a piezo element such that when an appropriate electrical signal is applied (which is indicated by the wires 650A and 650B shown in FIG. 6), the body 600 can expand or contract in the axial direction. Other materials known in the prior art, such as electroactive polymers and the like, may be used instead of a piezo element. Such variation of the axial expansion of the body 600 may be used, for example, to vary an axial contact pressure of the rotor 210 relative to the stator 220 during a switching operation of the valve 300, for example, by reducing the contact pressure before, during, and/or after the switching operation. Such a reduction of the contact pressure can, for example, reduce or even completely prevent wear of the valve 300, in particular an abrasion of the rotor 210 with respect to the stator 220.

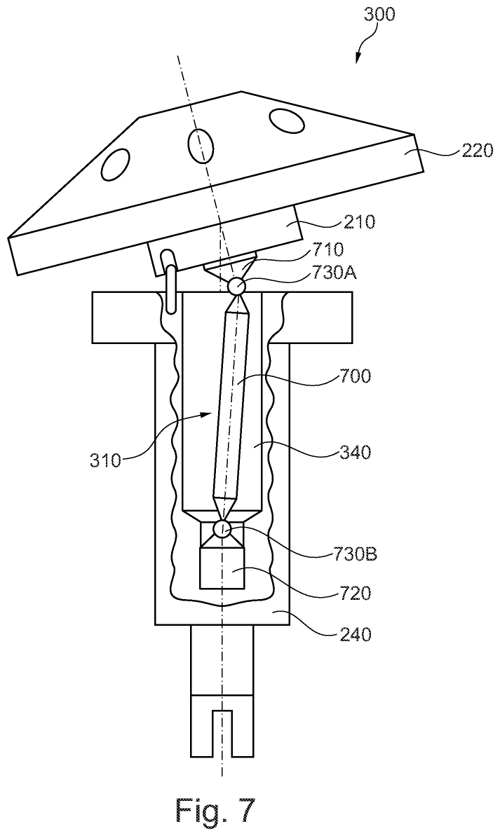

FIG. 7 shows, in accordance with the illustration of FIG. 3, a further embodiment of the valve 300. In contrast to the embodiment according to FIG. 3, the compensation element 310 in FIG. 7 comprises one or more spherical joints (each with one or more spherical surfaces).

In the exemplary embodiment shown in FIG. 7, the compensation element 310 again comprises an elongated base body 700 and an upper pressing element 710 and a lower pressing element 720. The upper pressing element 710 abuts against the rotor 210, while the lower pressing element 720 rests within the axial recess 340 of the drive 240 and is preferably held therein accordingly. A first ball joint 730A is arranged between the upper pressing element 710 and the elongated base body 700, and a second ball joint 730B is arranged on the axially opposite side between the elongated base body 700 and the lower pressing element 720. Each of the ball joints 730 may comprise one or more spherical surfaces, which may correspondingly cooperate with each other and may form one or more bearing points. Accordingly, an axial angular misalignment between the rotor 210 and the drive 240, as again exaggeratedly illustrated here, may be compensated for without compromising an axial preload of the drive 240 relative to the rotor 210 and thus relative to the stator 220.

The exemplary embodiment of the compensation element 310 shown in FIG. 7 can preferably also be designed as an assembly, e.g. by pressing corresponding balls of the ball joints 730 into corresponding recesses of the base body 700 and/or the pressing elements 710/720.

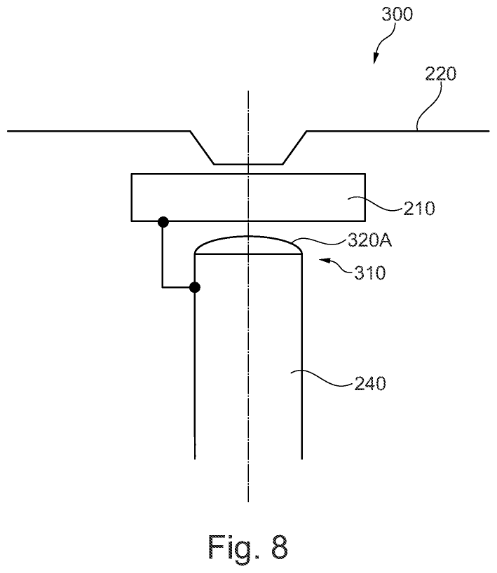

FIG. 8 schematically shows a further embodiment in which the compensation element 310 is formed by the drive 240 or is a part thereof. The drive 240 is formed, at least in a region adjacent to the rotor 210, as a rotatable shaft comprising a spherical surface 320A on its end face opposite to the rotor 210. In one operating state of the valve 300, the drive 240 axially urges the rotor 210 against the stator 220 with the spherical surface 320A abutting against the rotor 210. An axial rotational motion of the drive 240 is thus transmitted to the rotor 210, allowing the rotor 210 to be rotated in an axial direction and relative to the stator 220. The drive 240 may preferably be fixedly clamped at its end opposite the spherical surface 320A (not shown in FIG. 8) or may be part of a rotatable motor, as is sufficiently known in the prior art.

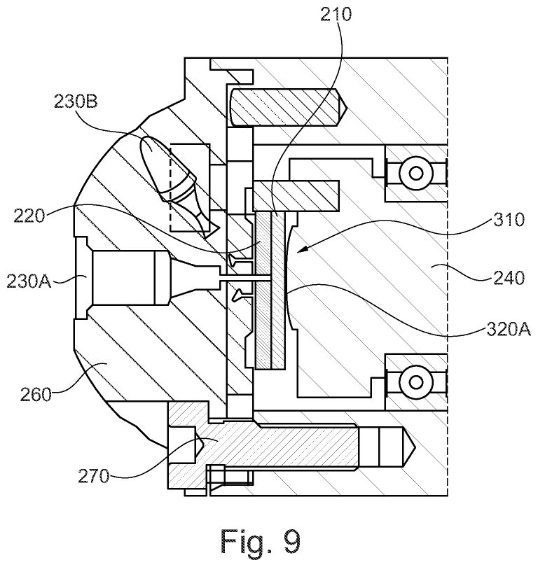

FIG. 9 shows a further embodiment according to that in FIG. 8, whereby the representation corresponds to FIG. 2, so that what has been said about FIG. 2 applies here accordingly. In the partial representation of FIG. 9, only the left-hand part of the representation in FIG. 2 is shown for the sake of clarity. According to the representation in FIG. 8, the shaft of the drive 240 comprises a spherical surface 320A on its side adjacent to the rotor 210, so that the drive 240 forms the compensation element 310. The radius of this spherical surface 320A can be selected in such a way that only a slight curvature results in relation to the flat contact surface of the rotor 210.

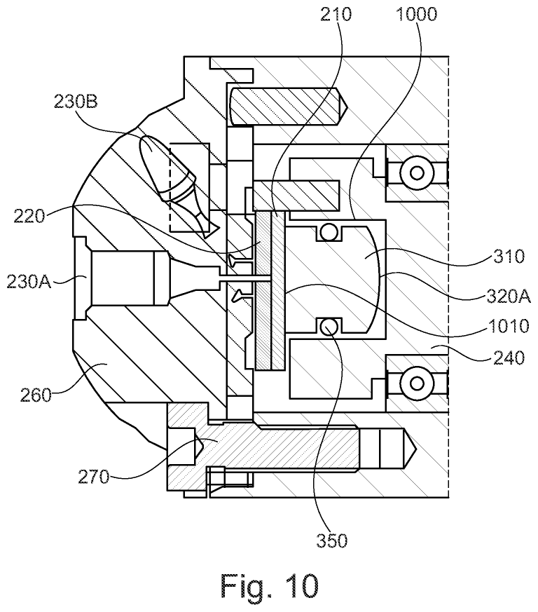

FIG. 10 shows a further embodiment and corresponds in its representation to FIG. 9. In contrast to the embodiment according to FIG. 9, the embodiment of FIG. 10 comprises a compensation element 310 separate from the drive 240, which can preferably lie in an axial recess 1000 of a shaft of the drive 240, as shown in FIG. 10. The compensation element 310 comprises a spherical surface 320A that is axially opposite the drive 240, or that abuts the side of the axial recess 1000 that is in the direction of the rotor 210. An end face 1010 axially opposite the spherical surface 320A, which abuts the rotor 210 during operation of the valve 300 and rotationally entrains the rotor 210, is preferably flat, so that the end face 1010 abuts the rotor 210 in a planar manner. In a further embodiment not shown here, the end face 1010 may also have a spherical surface 320, for example corresponding to the illustration shown in FIG. 3. The compensation element 310 of the embodiment shown in FIG. 10 may be radially retained and/or positioned with respect to the lateral transformations of the recess 1000 by a corresponding elastic element 350, corresponding to the embodiment shown in FIG. 3. Preferably, the elastic element 350 is formed by an O-ring, although several O-rings may also be used.

1. A valve for a high-performance chromatography system for separating components of a sample liquid introduced into a mobile phase, the valve comprising:
a rotor and a stator, wherein a flow path can be established or inhibited by a rotational movement of the rotor relative to the stator; and
a compensation element which is axially arranged together with the rotor and the stator, and which, in an operating state of the valve, effects an axial pressing of the rotor against the stator,
wherein the compensation element comprises an elongated base body having at least one spherical surface to compensate for axial misalignment between the rotor and the stator.

2. The valve according to claim 1, comprising at least one of the following features:
the at least one spherical surface is located at an axial end face of the elongated base body;
the elongated base body comprises a respective end face with a spherical surface in the axial direction;
the elongated base body extends substantially in the axial direction in the operating state of the valve.

3. The valve according to claim 1, comprising at least one of the following features:
the compensation element comprises one or more pivot points, each formed by a spherical surface;
the compensation element comprises one or more pivot points each formed by a spherical surface, wherein the pivot point or points each comprises a bearing location where two of the spherical surfaces roll on each other.

4. The valve according to claim 1, wherein the compensation element comprises two spherical surfaces, so that in case of an axial misalignment between the rotor and the stator, the spherical surfaces can move against each other to compensate for the axial misalignment.

5. The valve according to claim 1, wherein the compensation element is configured to compensate for a lateral misalignment of the rotor relative to the stator.

6. The valve according to claim 1, comprising at least one of the following features:
the compensation element is arranged together with the rotor and the stator axially in the direction of an axis of rotation of the rotor;
the compensation element is configured such that in the operating state of the valve, an axial force acts on the at least one spherical surface to cause the axial pressing of the rotor relative to the stator.

7. The valve according to claim 1, comprising a drive for moving the rotor.

8. The valve according to claim 7, comprising at least one of the following features:
the drive comprises a rotatable shaft which can in particular be driven by a motor;
the compensation element is arranged axially between the drive and the rotor or the stator;
the compensation element is arranged axially between a housing of the valve and the stator, wherein the compensation element acts axially on a first side of the stator, the drive acts on a second side via the rotor, and the second side is arranged axially opposite to the first side;
the compensation element is a part of the drive;
the drive comprises a rotatable shaft which forms the compensation element and comprises an end face with the at least one spherical surface which abuts against the rotor in the operating state of the valve.

9. The valve according to claim 1, wherein the compensation element comprises a first end and a second end axially disposed in opposite directions in the operating state of the valve, the first end comprising a first spherical surface such that the compensation element can tilt axially at the first spherical surface to compensate for the axial misalignment between the rotor and the stator.

10. The valve according to claim 9, comprising at least one of the following features:
wherein the second end of the compensation element comprises a second spherical surface such that the compensation element can tilt at the second spherical surface to compensate for the axial offset between the rotor and the stator;
wherein the second end of the compensation element comprises a second spherical surface such that the compensation element can tilt at the second spherical surface to compensate for the axial offset between the rotor and the stator, and wherein a direction of lift-off at the second spherical surface is opposite to a direction of lift-off at the first spherical surface.

11. The valve according to claim 10, wherein the compensation element has an elongated shape in the axial direction.

12. The valve according to claim 1, comprising at least one of the following features:
wherein the compensation element comprises at least one ball joint with at least one spherical surface;
wherein the compensation element comprises at least two ball joints at axially opposite ends of the compensation element.

13. The valve according to claim 1, wherein, by a relative movement of the rotor with respect to the stator, a first effective surface of the rotor can be brought into connection with a second effective surface of the stator and a flow path can be established or inhibited.

14. The valve according to claim 1, comprising at least one of the following features:
the valve is a high-pressure switching valve for high performance liquid chromatography;
the valve comprises a housing in which one or more of the rotor, the stator, the drive, and the compensation element are disposed;
the stator comprises a plurality of connection ports, each for being able to bring about a fluidic coupling;
the rotor cooperates with the stator in predetermined switching positions defined by associated angular positions to fluidically connect or disconnect predetermined connection ports;
the rotor is rotatably mounted by a bearing and pressing device, and is subjected to a predetermined pressing force in the direction of the stator;
the rotor is rotatably mounted by a bearing and pressing device, and the bearing and pressing device comprises the compensation element which acts on the rotor to transmit the pressing force;
the compensation element comprises a head portion which acts on the rotor with an application surface;
the compensation element comprises a foot portion with which the compensation element is supported against a unit of the bearing and pressing device that generates the pressing force or against an element of the bearing and pressing device that transmits the pressing force;
the compensation element is configured in such a way that the application surface of a head region impacts the rotor over the entire surface, even during wobbling movements of the rotor, in any angular position of the rotor, and a substantially uniform pressure distribution is thereby generated in a contact plane between the rotor and the stator;
the compensation element is formed as a rod-shaped element;
the compensation element is made of steel or ceramic.

15. The valve according to claim 1, comprising at least one of the following features:
the rotor is axially fixed within the valve, and the stator is configured such that it can align elastically with respect to the rotor;
the stator is axially fixed within the valve, and the rotor is configured such that it can align elastically with respect to the rotor.

16. The valve according to claim 1, wherein:
the rotor comprises a first effective surface and the stator comprises a second effective surface;
by a relative movement of the rotor with respect to the stator, the first effective surface can be brought into connection with the second effective surface and a flow path can be established or inhibited; and
the stator comprises an elastic region to compensate for an axial angle between the rotor and the stator so that the first effective surface and the second effective surface can be aligned parallel to each other.

17. The valve according to claim 16, wherein:
the stator comprises an outer region and an inner region;
the inner region comprises the second effective surface; and
the outer region is connected to the inner region via the elastic region so that the inner region is elastically movable relative to the outer region through the elastic region.

18. The valve according to claim 17, comprising at least one of the following features:
the outer region is fixed with respect to the rotor and the inner region can align itself elastically with respect to the rotor;
the elastic region comprises one or more webs, each of which is connected to the outer region on one side and to the inner region on the opposite side, so that the inner section can tilt with respect to the outer section.

19. A high performance chromatography system, comprising:
a pump for moving a mobile phase;
a stationary phase for separating components of a sample liquid introduced into the mobile phase; and
a valve for establishing or inhibiting a flow path of the mobile phase, the valve comprising:
a rotor and a stator, wherein a flow path can be established or inhibited by a rotational movement of the rotor relative to the stator; and
a compensation element which is axially arranged together with the rotor and the stator, and which, in an operating state of the valve, effects an axial pressing of the rotor against the stator,
wherein the compensation element comprises an elongated base body having at least one spherical surface to compensate for axial misalignment between the rotor and the stator.

20. A method, in a high-performance chromatography system for separating components of a sample liquid introduced into a mobile phase, for a valve comprising a rotor and a stator, wherein a flow path can be established or inhibited by rotational movement of the rotor relative to the stator, the method comprising:
compensating for axial misalignment between the rotor and the stator by forming a pivot point on at least one spherical surface.
